(19) United States
(12) Patent Application Publication
(10) Pub. No.: US 2007/0193315 A1
(43) Pub. Date: Aug. 23, 2007

(54) Auxiliary operation member for removing a steering wheel

(76) Inventor: Yasuaki Ichikawa, Tokyo (JP)

Correspondence Address: FROST BROWN TODD, LLC, 2200 PNC CENTER, 201 E. FIFTH STREET, CINCINNATI, OH, 45202, US

(21) Appl. No.: 11/453,771

(22) Filed: Jun. 15, 2006

(30) Foreign Application Priority Data
Jan. 12, 2006 (JP) 2006-000163

(51) Int. Cl. E05B 13/10

(52) U.S. Cl. 70/207

(57) ABSTRACT

Provided is an auxiliary operation member for removing a steering wheel used for a steering wheel attachment structure including: a fixed side joint member attached to a steering shaft; an attachment side joint member that is attached to the steering wheel and is attached and detached by fitting with respect to the fixed side joint member; a lock mechanism for locking and unlocking fitting of the fixed side joint member and the attachment side joint member; and a safety button capable of protruding and retracting, for inhibiting an unexpected unlocking operation of the lock mechanism, characterized in that: the auxiliary operation member is attached to the lock mechanism; and when the lock mechanism is unlocked, the auxiliary operation member is capable of switching a pushing-in-function of pushing-in the safety button and a nonpushing-in-function of not pushing-in the safety button to each other before an operation of the lock mechanism.

### BACKGROUND OF THE INVENTION

I. Field of the Invention

The present invention relates to an auxiliary operation member for removing a steering wheel, which is after-fitted to a steering wheel attachment structure capable of attaching and detaching a steering wheel of an automobile or the like with respect to a steering shaft with a single operation.

II. Description of Related Art

Recently, a steering wheel is replaced depending on a driving style of a user, and the steering wheel is temporarily removed for a purpose of preventing an automobile from being thieved during parking. Under such circumstances, there is a demand for a development of a steering wheel attachment structure capable of being easily attached and detached the steering wheel to and from a steering shaft.

Conventionally, there is known a steering wheel attachment structure capable of being easily attached and detached a steering wheel to and from a steering shaft described, for example, in JP laid open publication No. 2002-178933 A.

As shown in FIGS. 1 and 2, the conventional steering wheel attachment structure includes a fixed side joint member 1 attached to a steering shaft A, and an attachment side joint member 2 attached to a steering wheel B and detachably fitted to the fixed side joint member 1. The steering wheel B can be adapted to be attached and detached to and from the steering shaft A with a single operation of drawing and inserting the steering wheel B together with the attachment side joint member 2 in fitting direction of the fixed side joint member 1 and the attachment side joint member 2.

Further, the conventional steering wheel attachment structure is provided with a lock mechanism 3 for locking and unlocking the fitting between the fixed side joint member 1 and the attachment side joint member 2. The locking and unlocking in the lock mechanism 3 is performed by sliding a sleeve-shaped operation part 31 externally mounted on the fixed side joint member 1 and the attachment side joint member 2.

Further, the conventional steering wheel attachment structure is provided with, although not disclosed in said publication, a safety button 4 for inhibiting an unexpected unlocking operation of the lock mechanism 3. The safety button 4 has a configuration in which a head part 42 of a truncated cone shape is provided on a cylindrical base 41. The safety button 4 is elastically biased in a protrusion direction with a spring member or the like with respect to either one of the fixed side joint member 1 and the attachment side joint member 2 (the attachment side joint member 2 in FIGS. 1 and 2) positioned on an unlocking slide side of the operation part 31 of the lock mechanism 3, and is arranged so as to be capable of being protruded and retracted, to make the base 41 an obstacle for the operation part 31 of the lock mechanism 3 to slide (see FIG. 2).

In the conventional steering wheel attachment structure, when the steering wheel is removed, although it is necessary to push-in the safety button 4 with a finger tip or the like to prevent the safety button 4 from becoming an obstacle for the operation part 31 of the lock mechanism 3 to slide, there is a problem that depending upon a size of a hand and a grip strength of an operator, it may become difficult to push-in the safety button placed below the steering wheel.

### SUMMARY OF THE INVENTION

The present invention has been made in view of the above-mentioned problem, and it is an object of the present invention to provide an auxiliary operation member for removing a steering wheel that can be after-fitted to a steering wheel attachment structure and facilitate an operation of a safety button for unlocking.

In order to achieve the above-mentioned object, an auxiliary operation member for removing a steering wheel according to the present invention adopts measures according to the following respective aspects.

That is, according to a first aspect of the present invention, there is provided an auxiliary operation member for removing a steering wheel, including: a fixed side joint member attached to a steering shaft; an attachment side joint member that is attached to the steering wheel and is attached and detached by fitting with respect to the fixed side joint member; a lock mechanism for locking and unlocking fitting of the fixed side joint member and the attachment side joint member; and a safety button capable of being protruded and retracted, for inhibiting an unexpected unlocking operation of the lock mechanism, characterized in that: the auxiliary operation member is attached to the lock mechanism; and when the lock mechanism is unlocked, the auxiliary operation member is capable of switching a pushing-in-function of pushing-in the safety button and a nonpushing-in-function of not pushing-in the safety button to each other before an operation of the lock mechanism.

According to the measure described above, the auxiliary operation member can be attached to the lock mechanism, and when the steering wheel is to be removed, by performing the switching, the safety button can be pushed-in before unlocking the lock mechanism. Further, when the steering wheel is not to be removed, by performing the switching, the safety button can be prevented from being pushed-in in a case of unexpected unlocking of the lock mechanism.

Further, according to the second aspect of the invention, in the first aspect, the head part formed on the truncated cone shape of the safety button is characterized in being pushed laterally to push-in the safety button, wherein according to this means the safety button can be pushed-in by lateral pressure force.

Further, according to the third aspect of the invention, in the second aspect, the lock mechanism comprises an operation part for operating locking and unlocking of the lock mechanism formed in a sleeve shape so that the operation part is externally mounted slidably on the fixed side joint member and the attachment side joint member; and the auxiliary operation member comprises a sleeve-shaped body part attached by being fitted to the operation part of the lock mechanism composed of a portion whose axial length on the safety button side is equal to or shorter than the axial length of the operation part of the lock mechanism.

According to this aspect, by directing the different axial length portion of the operation part selectively to the safety button, the pushing-in-function and the nonpushing-in-function can be switched.

Further, according to the fourth aspect of the present invention, in the third aspect, the body part is provided with a ring member which has an inner diameter smaller than an outer diameter of the operation part of the lock mechanism, and which is attached to an end of the body part on the safety button side.

According to the above means the safety button pushed-in partway by the body part is further pushed-in by the ring member.

According to the fifth and sixth aspects of the invention, in the third or fourth aspect, at least the body part is rotatable to the fixed side joint member and attachment side joint member.

According to the above means, by the rotation of the body part the pushing-in-function and the nonpushing-in-function are switched.

### EFFECT OF THE PRESENT INVENTION

The auxiliary operation member for removing a steering wheel according to the present invention is attached to the lock mechanism, and when the steering wheel is to be removed, by performing the switching, the safety button can be pushed-in before the unlocking of the lock mechanism. Therefore, the auxiliary operation member can be after-fitted to the steering wheel attachment structure, and has an effect of facilitating the operation of the safety button for unlocking. Further, when the steering wheel is not to be removed, by performing the switching, the safety button can be prevented from being pushed-in in the case of unexpected unlocking of the lock mechanism. Therefore, there is an effect that the function of the safety button is not inhibited unexpectedly.

Further, according to a second aspect of the present invention, the safety button can be pushed-in with a lateral pressure force, so a structure of the auxiliary operation member can be prevented from increasing in size.

Further, according to a third aspect of the present invention, a pushing-in-function and a nonpushing-in-function can be switched by selectively directing each of portions having different shaft lengths of a body part with respect to the safe button, so the structure can be prevented from being complicated.

Further, according to a fourth aspect of the present invention, the safety button pushed partway by the body part is further pushed with a ring member, so the unnecessary collision between the safety button and the operation part of the lock mechanism can be prevented.

Further, according to fifth and sixth aspects of the present invention, the pushing-in-function and the nonpushing-in-function can be switched to each other by the rotation of the body part, so an operation is easy.

### BRIEF DESCRIPTION OF THE DRAWINGS

In the accompanying drawings:

FIG. 1 is a side cross-sectional view of a conventional example showing an attached state of a steering wheel;

FIG. 2 is a partial enlarged view showing an operation state of FIG. 1;

FIG. 3 is a perspective view showing a non-attached state of an auxiliary operation member for removing a steering wheel according to a preferred embodiment of the present invention;

FIG. 4 is a view showing an attached state of FIG. 3;

FIG. 5 is a side cross-sectional view showing an attached state of the steering wheel after the state of FIG. 4;

FIG. 6 is a partial enlarged view showing an operation state of FIG. 5;

FIG. 7 is a side cross-sectional view showing an attached state of the steering wheel after the state of FIG. 4, showing a positional relationship different from that of FIG. 5;

FIG. 8 is a partially enlarged view showing another operation state of FIG. 5;

FIG. 9 shows an operation state following that of FIG. 8; and

FIG. 10 shows an operation state following that of FIG. 9.

### DETAILED DESCRIPTION OF THE PREFERRED EMBODIMENT

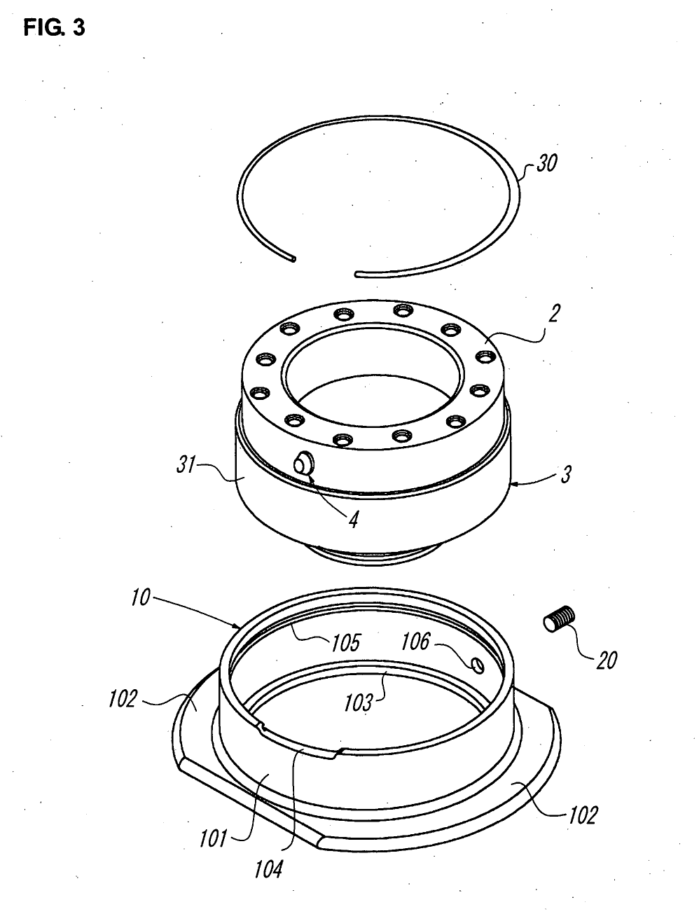

Hereinafter, a description will be made of an auxiliary operation member for removing a steering wheel according to a preferred embodiment of the present invention with reference to FIGS. 3 to 10.

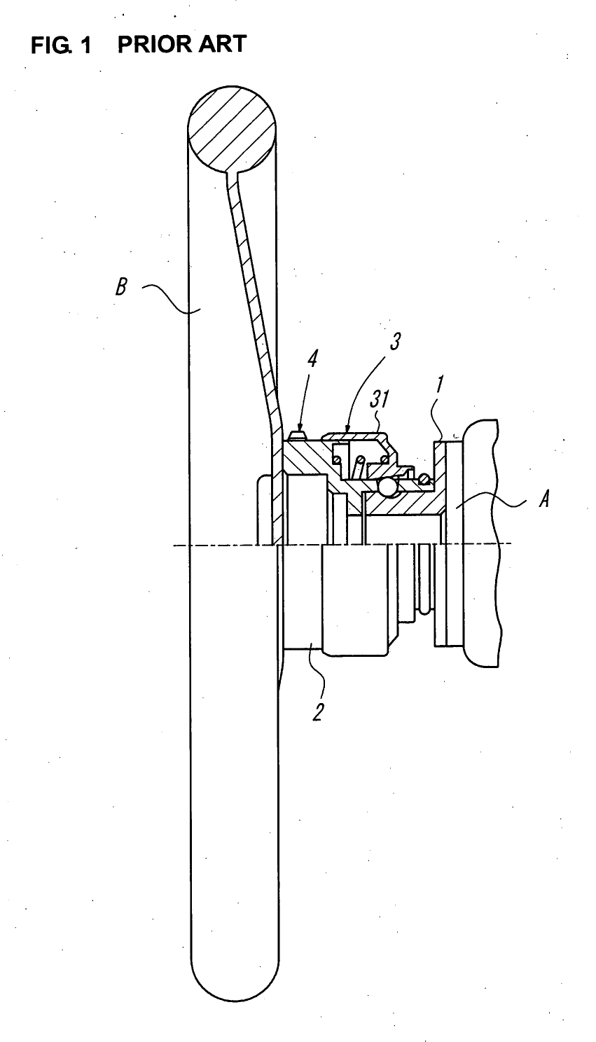

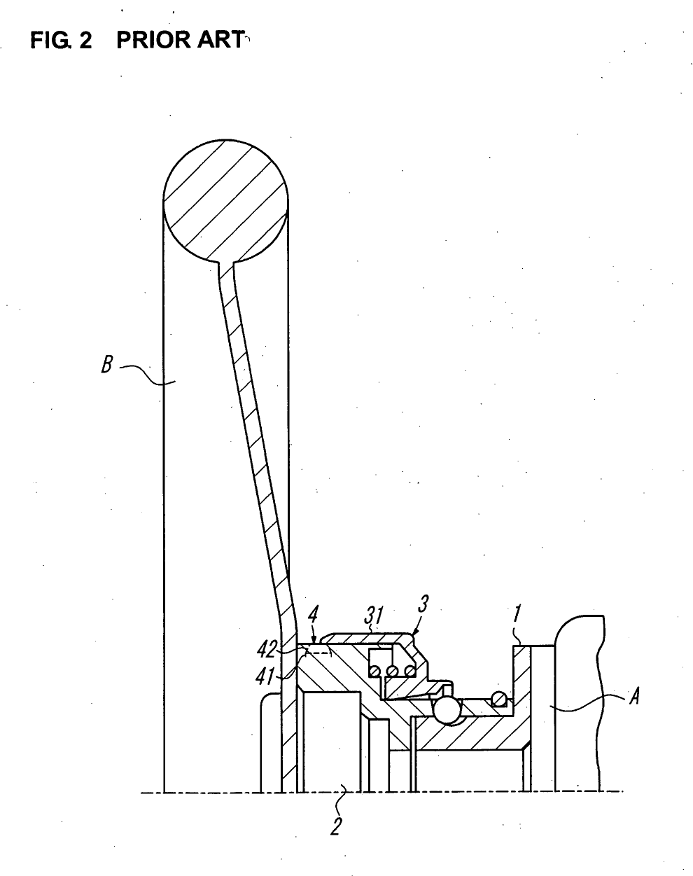

In this embodiment, an auxiliary operation member for removing a steering wheel is described as being after-fitted to an operation part 31 of a lock mechanism 3 to be used for an attachment structure of a steering wheel composed of a fixed side joint member 1, an attachment side joint member 2, the lock mechanism 3, and a safety button 4 shown in FIGS. 1 and 2, as described in a section of summary of the invention.

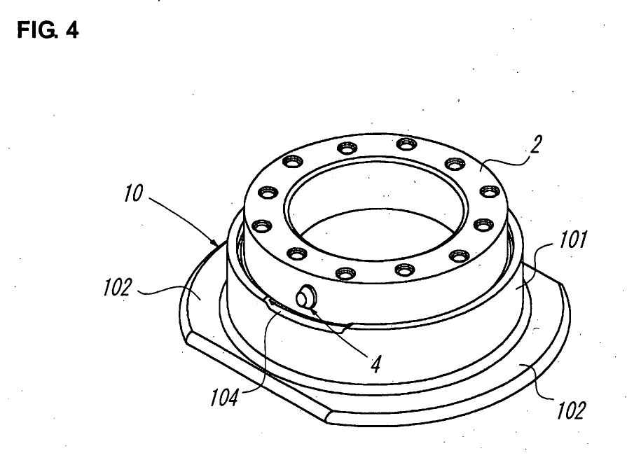

This embodiment is composed of a body part 10, an attachment screw 20, and a ring member 30 as shown in FIGS. 3 and 4.

The body part 10 is provided with a flange-shaped hand grip section 102, which protrudes in a direction orthogonal to an axis of a sleeve-shaped tube part 101 at an angle of 90°, on one end of the tube part 101. Over an entire inner periphery of one end of the tube part 101, a detachment-preventing flange 103 is provided, which comes into contact with the sleeve-shaped operation part 31 of the lock mechanism 3 so as not to be detached from the operation part 31. On the other end of the tube part 101, a notch part 104 is provided so as to be substantially orthogonal to the hand grip section 102. In other words, the tube part 101 includes a portion having a long axial length and a portion having a short axial length. In an inner peripheral surface close to the other end of the tube part 101, a ring groove 105 is formed to which the ring member 30 is fitted. The ring groove 105 communicates with the notch part 104. A screw hole 106 passes through the middle of the tube part 101 so as to be substantially orthogonal to the hand grip section 102.

The attachment screw 20 is of a DELscrew, and is screwed in the screw hole 106 of the body part 10 to fasten the body part 10 to the operation part 31 of the lock mechanism 3.

The ring member 30 is composed of a C-ring. A portion of the ring member 30 corresponding to a length of the notch part 104 of the body part 10 is removed, and an inner diameter of the ring member 30 is set to be smaller than an outer diameter of the operation part 31 of the lock mechanism 3.

The lock mechanism 3 will be described additionally. The lock mechanism 3 is configured in such a manner that a lock ball 32 accommodated in the attachment side joint member 2 attached to a steering wheel B engages with a lock groove 33 provided in the fixed side joint member 1 attached to a steering shaft A. The lock ball 32 is pressed elastically to the lock groove 33 with the operation part 31 being elastically pressed in an opposite direction of the safety button 4 with a spring 34. Thus, when the operation part 31 is slid in a direction of the safety button 4 against the spring 34, the elastic pressure of the lock ball 32 with respect to the lock groove 33 is cancelled, whereby the unlocking is performed. The operation part 31 is rotatable.

In this embodiment, as shown in FIGS. 3 and 4, the body part 10 is fitted to the attachment side joint member 2 and lock mechanism 3 which are integrated with each other from the notch part 104 side toward the lock mechanism 3, whereby the tube part 101 is fastened to the operation part 31 of the lock mechanism 3 with the attachment screw 20. Next, the ring member 30 is fitted from an opposite side of the body part 10 to be attached to the ring groove 105 of the body part 10. At this time, the removed portion of the ring member 30 is positioned at the notch part 104 of the body part 10.

After that, the steering wheel B is attached to the attachment side joint member 2, thereby configuring an attachment structure capable of attaching and detaching a steering wheel with a single operation as described above. That is, the auxiliary operation member can be after-fitted easily to a steering wheel attachment structure.

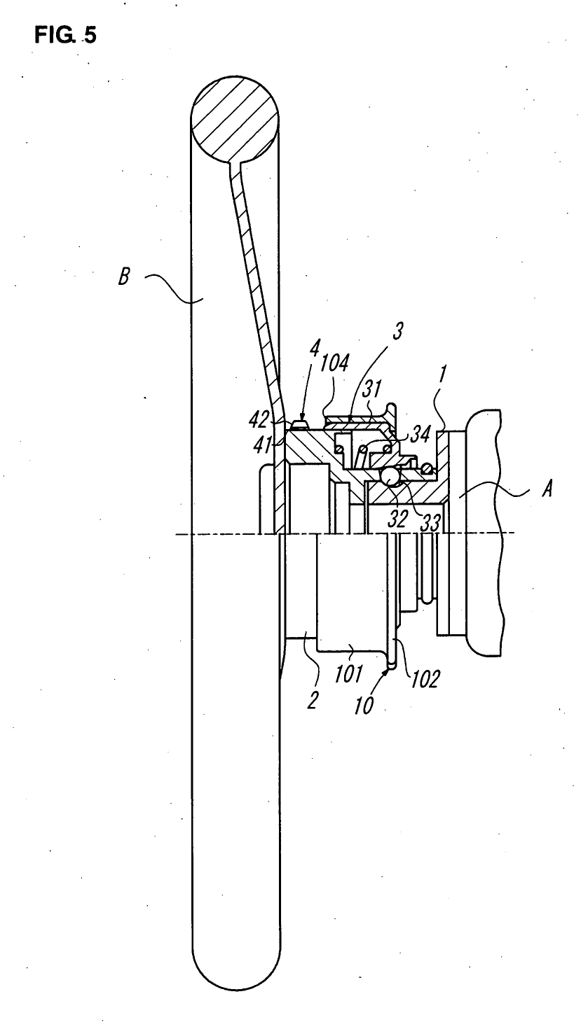

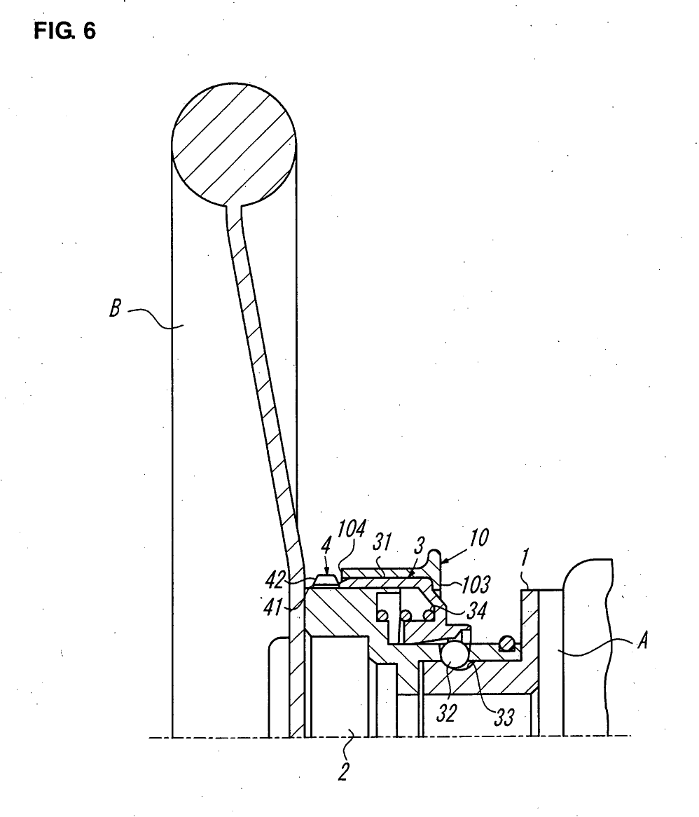

After the auxiliary operation member is after-fitted, the body part 10 is retained in a state shown in FIGS. 5 and 6, except that the steering wheel B is removed. To be more specific, as shown in FIG. 5, the notch part 104 of the body part 10 is opposed to the safety button 4. In this state, even when the operation part 31 of the lock mechanism 3 and the body part 10 slid unexpectedly, the operation part 31 of the lock mechanism 3 collides with the base 41 of the safety button 4, thereby preventing the lock mechanism 3 from being unlocked.

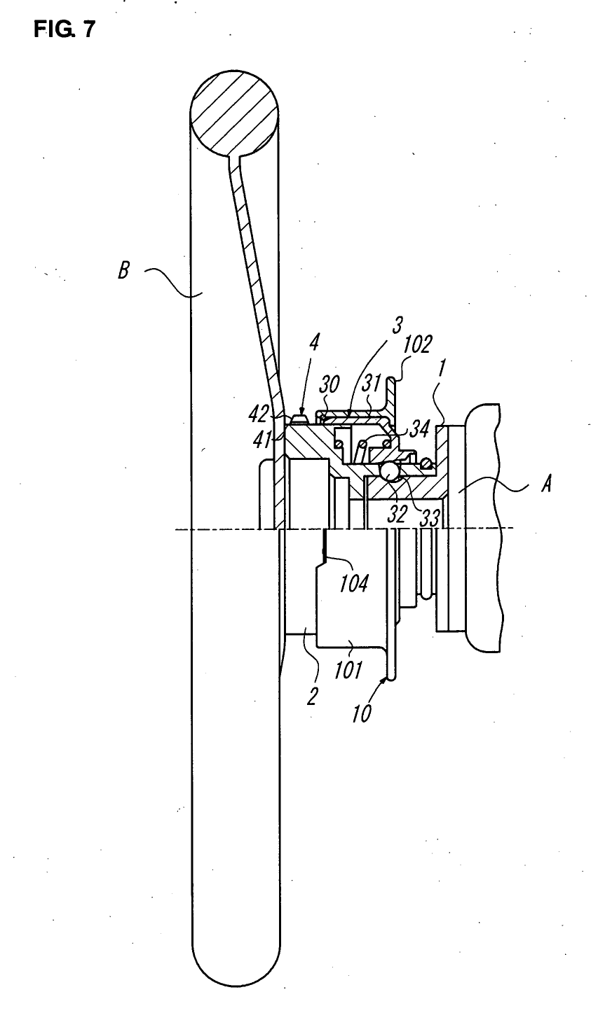

When the steering wheel B is removed, as shown in FIG. 7, the body part 10 is rotated together with the operation part 31 of the lock mechanism 3 so as not to oppose the notch part 104 of the body part 10 to the safety button 4. This operation is easy since it involves only rotation.

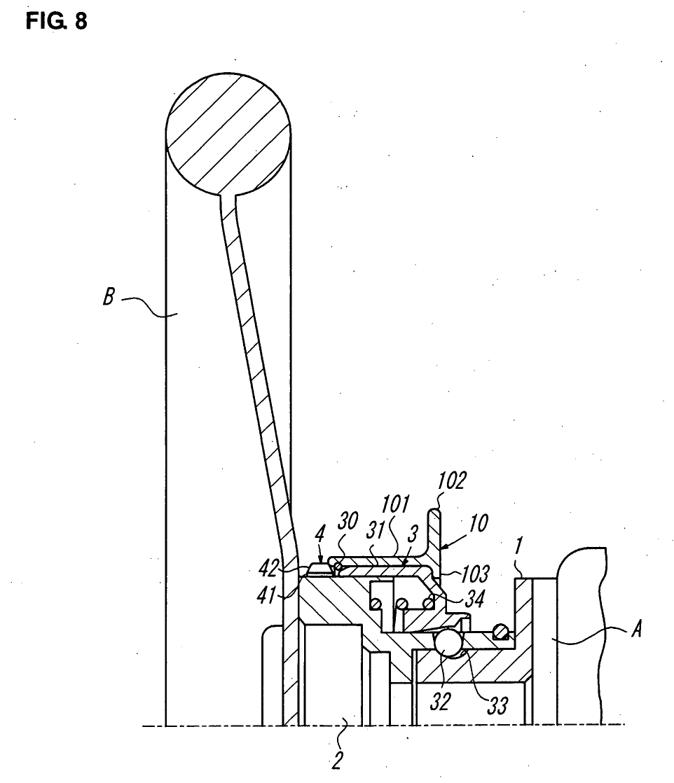

Then, the hand grip section 102 of the body part 10 is held, and the body part 10 is slid toward the steering wheel B together with the operation part 31 of the lock mechanism 3. The slid body part 10 pushes a head part 42 in a truncated cone shape of the safety button 4 from a side as shown in FIG. 8, thereby pushing-in the entire safety button 4. Thus, the safety button 4 can be pushed-in, even if the body part 10 is not enlarged.

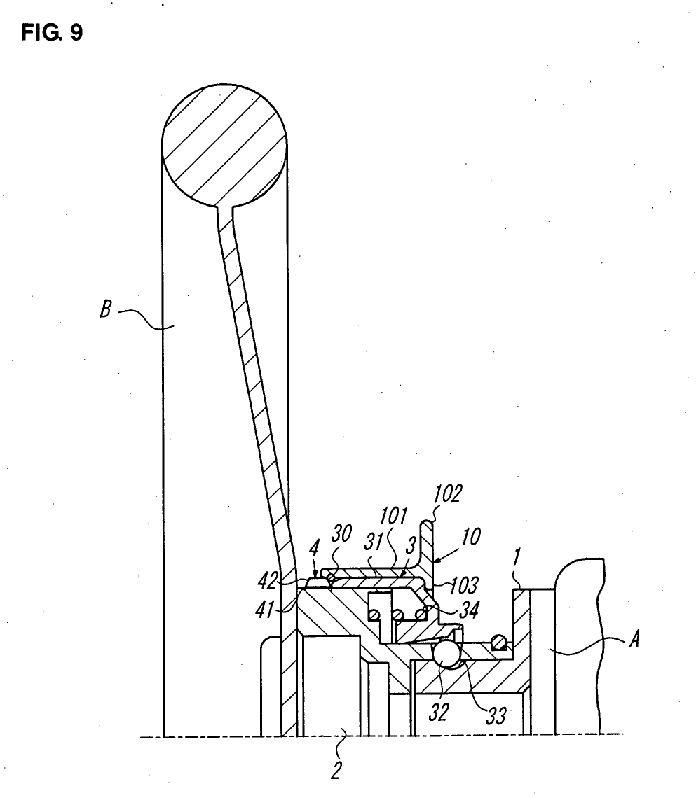

Further, when the sliding of the body part 10 and the operation part 31 of the lock mechanism 3 is continued, as shown in FIG. 9, while the body part 10 presses the top of the safety button 4 so as to suppress the recovery due to the elastic pressure, the ring member 30 pushes the head part 42 formed in a truncated cone shape of the safety button 4 from a lateral side, thereby further pushing-in the entire safety button 4.

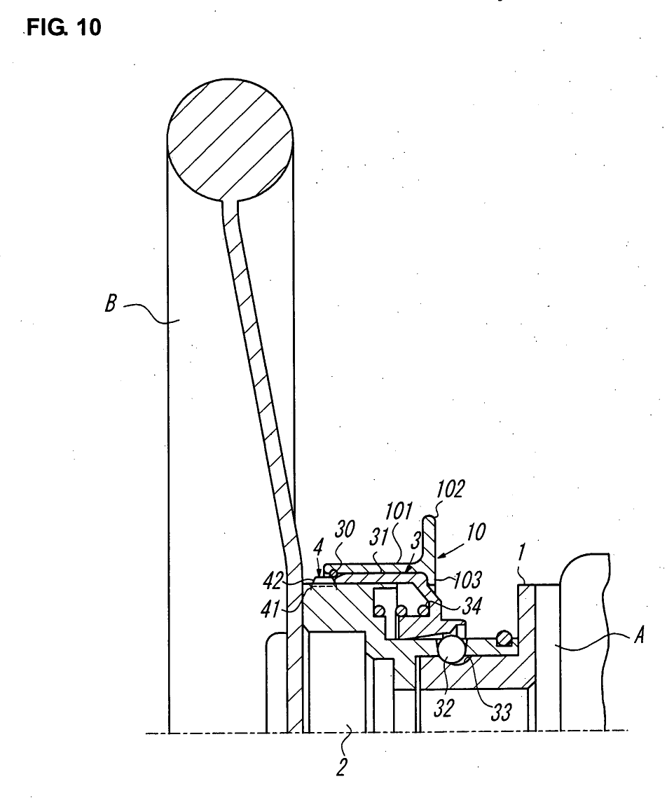

When the sliding of the body part 10 and the operation part 31 of the lock mechanism 3 is further continued, as shown in FIG. 10, while the ring member 30 presses the top of the safety button 4 so as to suppress the recovery due to the elastic pressure, the ring member 30 of the operation part 31 of the lock mechanism 3 pushes the head part 42 formed in a truncated cone shape of the safety button 4 from a lateral side, thereby further pushing-in the entire safety button 4. At this time, the safety button 4 is substantially embedded inside the attachment side joint member 2, so a large collision shock will not be given to the operation part 31 of the lock mechanism 3.

Consequently, the safety button 4 is completely embedded inside the attachment side joint member 2, thereby permitting the operation part 31 of the lock mechanism 3 to be further slid. The lock mechanism 3 is thus unlocked, which enables the steering wheel B to be removed.

In this embodiment, by selecting one of portions having different axial lengths of the body part 10 and directing the selected portion to the safety button 4, the pushing-in-function and the nonpushing-in-function can be switched to each other. Therefore, the configurations of the body part 10 and the like can be prevented from being complicated.

In addition to each shown example, the body part 10 and the operation part 31 of the lock mechanism 3 may be pressed against each other with packing or the like to be fixed.

Further, in a case where the safety button 4 is provided on the fixed side joint member 1 to be attached to the steering shaft A, the body part 10 can also be configured in an opposite configuration.

Further, in the case where the operation part 31 of the lock mechanism cannot rotate, the body part 10 may allow to be rotated with respect to the operation part 31 of the lock mechanism 3 via a bearing or the like.

What is claimed is:

1. An auxiliary operation member for removing a steering wheel used for a steering wheel attachment structure comprising: a fixed side joint member attached to a steering shaft; an attachment side joint member that is attached to the steering wheel and is attached and detached by fitting with respect to the fixed side joint member; a lock mechanism for locking and unlocking fitting of the fixed side joint member and the attachment side joint member; and a safety button capable of protruding and retracting, for inhibiting an unexpected unlocking operation of the lock mechanism, wherein:
the auxiliary operation member is attached to the lock mechanism; and
when the lock mechanism is unlocked, the auxiliary operation member is capable of switching a pushing-in-function of pushing-in the safety button and a nonpushing-in-function of not pushing-in the safety button to each other before an operation of the lock mechanism.

2. An auxiliary operation member for removing a steering wheel according to claim 1, wherein the safety button comprises a head part having a truncated cone shape being pushed from a side, whereby the safety button is pushed-in.

3. An auxiliary operation member for removing a steering wheel according to claim 2, wherein:
the lock mechanism comprises an operation part for operating locking and unlocking of the lock mechanism formed in a sleeve shape so that the operation part is externally mounted slidably on the fixed side joint member and the attachment side joint member; and
the auxiliary operation member comprises a sleeve-shaped body part attached by being fitted to the operation part of the lock mechanism composed of a portion whose axial length on a safety button side is longer than the axial length of the operation part of the lock mechanism and a portion whose axial length on the safety button side is equal to or shorter than the axial length of the operation part of the lock mechanism.

4. An auxiliary operation member for removing a steering wheel according to claim 3, wherein the body part is provided with a ring member which has an inner diameter smaller than an outer diameter of the operation part of the lock mechanism, and which is attached to an end of the body part on the safety button side.

5. An auxiliary operation member for removing a steering wheel according to claim 3, wherein at least the body part is rotatable with respect to the fixed side joint member and the attachment side joint member.

6. An auxiliary operation member for removing a steering wheel according to claim 4, wherein at least the body part is rotatable with respect to the fixed side joint member and the attachment side joint member.
